(19) United States
(12) Patent Application Publication
(10) Pub. No.: US 2014/0317616 A1
(43) Pub. Date: Oct. 23, 2014

(54) CLOUD COMPUTING RESOURCE MANAGEMENT

(71) Applicant: Thomas P. CHU, Englishtown, NJ (US)

(72) Inventor: Thomas P. CHU, Englishtown, NJ (US)

(21) Appl. No.: 13/868,348

(22) Filed: Apr. 23, 2013

(51) Int. Cl. G06F 9/455

(52) U.S. Cl. CPC G06F 9/45533
USPC 718/1

(57) ABSTRACT

An illustrative cloud computing network includes a plurality of resources configured to run at least one virtual machine. At least one resource is configured to run a manager virtual machine for a user that automatically initiates a change in a number of virtual machines running for the user on at least one of the plurality of resources. The illustrative network may include a technique for forwarding communications when a virtual machine retires, a hierarchical addressing technique, or both.

### TECHNICAL FIELD

This disclosure generally relates to cloud computing. More particularly, and without limitation, this disclosure relates to managing resources in a cloud computing network.

### DESCRIPTION OF THE RELATED ART

Cloud computing has been increasing in popularity and capability. A cloud computing network includes a set of resources that are available to one or more users to complete various computing tasks. One advantage provided by cloud computing networks is that a user does not need to make the investment in the resources necessary to perform a desired computing task. Instead, the user accesses the cloud computing network resources on an as-needed basis.

User needs vary over time. Individual users will not have a consistent need for the network resources and the number of users may fluctuate over time. These changes in load on the cloud computing network give rise to a need to be able to adjust how the network resources are managed. There have been proposals to allow a user to specify the type and number of virtual machines needed for a particular task and proposals for how to configure the network resources in response to such user requests. Managing network resources in this manner presents several challenges.

### SUMMARY

An illustrative cloud computing network includes a plurality of resources configured to run at least one virtual machine. At least one resource is configured to run a manager virtual machine for a user that automatically initiates a change in a number of virtual machines running for the user on at least one of the plurality of resources.

An illustrative method of method of managing cloud computing resources includes using a manager virtual machine running on at least one resource for a user to automatically initiate a change in a number of virtual machines running for the user on at least one of a plurality of resources.

Various embodiments and their features will become apparent to those skilled in the art from the following detailed description of at least one example embodiment. The drawings that accompany the detailed description can be briefly described as follows.

### BRIEF DESCRIPTION OF THE DRAWINGS

FIG. 1 schematically illustrates an example cloud computing network designed according to an embodiment of this invention.

FIG. 2 schematically illustrates an example configuration of network resources.

FIG. 3 is a flowchart diagram summarizing an approach for creating or retiring virtual machines within the example cloud computing network.

FIG. 4 schematically illustrates a technique for routing communications within the example network.

FIG. 5 schematically illustrates an example addressing scheme useful with the example network.

FIG. 6 schematically illustrates another example addressing scheme.

### DETAILED DESCRIPTION

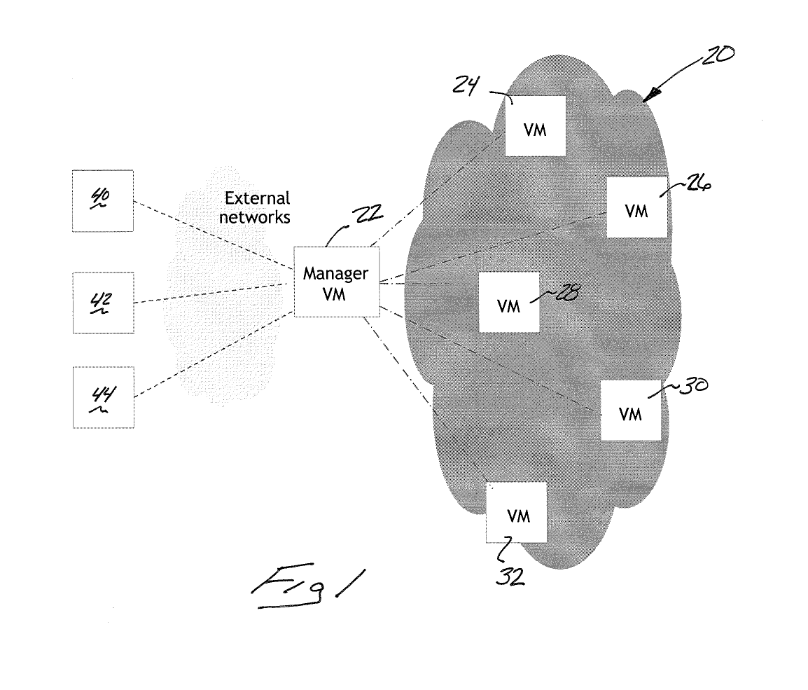

FIG. 1 schematically illustrates a cloud computing network 20. At least one processor is configured to run a manager virtual machine (VM) 22 for a user that is configured to manage the resources of the network 20 on behalf of the user. The manger VM 22 is configured to automatically initiate a change in the number of VMs 24, 26, 28, 30 and 32 (e.g., create or retire at least one VM) within the network 20. The VMs 24-32 may run on a set of resources, such as a plurality of processors or servers and provide cloud computing services to one or more users schematically shown at 40, 42, 44. The number of users and VMs will vary and only some of each are shown for discussion purposes.

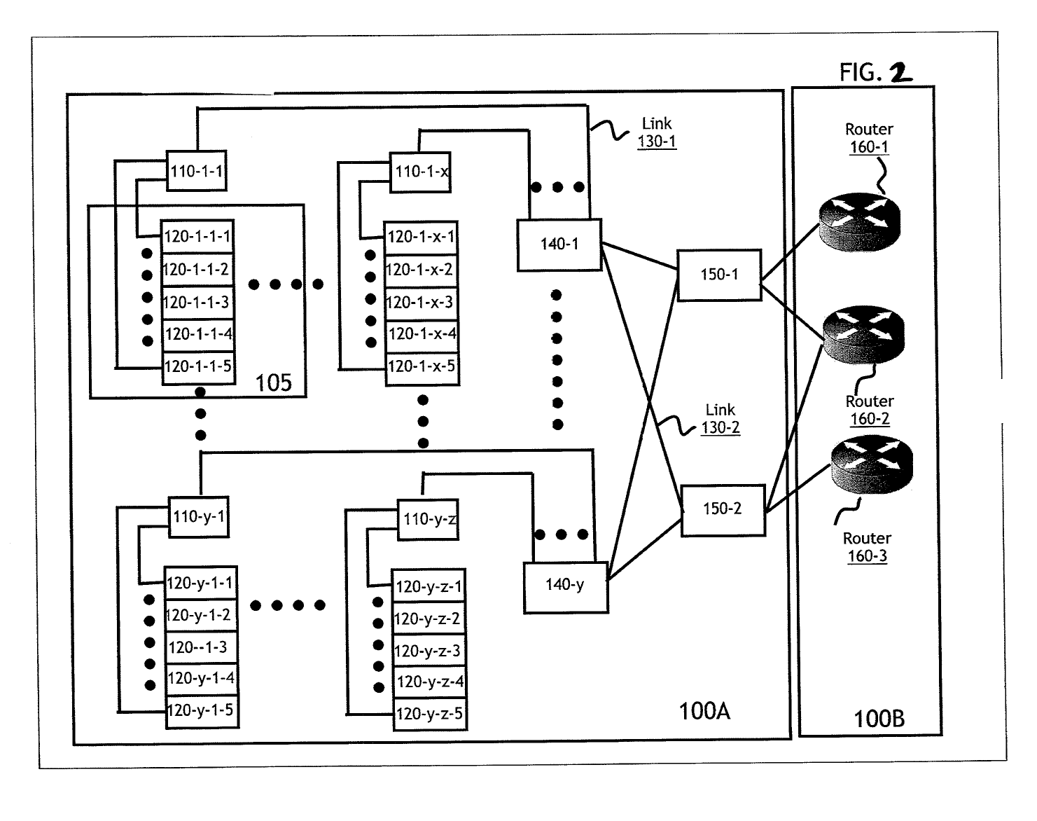

An example configuration of the network 20 is shown in FIG. 2. In this example, the cloud computing network 20 is arranged as a data center having a particular architecture that is useful to consider for discussion purposes. The arrangement in FIG. 2 is not necessarily limiting and other configurations may be useful.

The example cloud computing network architecture of FIG. 2 includes an example data center 100A and a network 100B. The data center 100A includes a plurality of resources, such as processors, 120-1-1-1-120-y-z-5 (collectively, resources 120). The processors or resources 120 are configured to run the plurality of virtual machines 24-32. In this example, the resources 120 are arranged in “y” rows, where each row contains a number (e.g., illustratively “x” or “y”) of racks of resources (e.g., rack 105) that are accessed through a communication path. The communication path communicatively connects resources 120 with network 100B via an appropriate one of the top of the rack (TOR) switches 110-1-1-110-y-z (collectively, TOR switches 110), an appropriate one of the end of the row (EOR) switches 140-1-140-n (collectively, EOR switches 140), an appropriate one of the layer 2 aggregation switches 150-1-150-n (collectively, aggregation switches 150) and appropriate links 130-1-130-2 (collectively, links 130).

Communication between the data center 100A and the network 100B goes through one of the aggregation switches 150, an appropriate one of the routers 160, and appropriate links 130. It should be appreciated that a data center may be arranged in any suitable configuration and that the illustrated data center 100A is just one example architecture being used for discussion purposes.

The TOR switches 110 switch data between resources in an associated rack and an appropriate EOR switch. For example, the TOR switch 110-1-1 switches data from resources in the rack 105 to the network 100B via an appropriate EOR switch (e.g., EOR switch 140-1).

Resources 120 may be any suitable devices or nodes, such as processors (e.g., compute nodes that are configured to perform at least one computing operation), memory, storage, switches, routers or network elements. It should be appreciated that while five resources are illustrated in each rack (e.g., rack 105), each rack may include fewer or more resources and each rack may contain different types or numbers of resources. In some embodiments, an application may be supported by multiple component instances such as virtual machines (VMs) or virtualized storage. These component instances may include varied resources connected within the data center network architecture 100A.

As illustrated, each resource 120 is labeled using a row-column-resource number nomenclature. For example, resource 120-2-3-4 would be the fourth resource in the rack residing in the second row and third column.

The EOR switches 140 switch data between an associated TOR switch and an appropriate aggregation switch. For example, the EOR switch 140-1 switches data from the TOR switches 110-1-1-210-1-x to the network 100B via an appropriate aggregation switch (e.g., aggregation switch 150-1 or 150-2).

The aggregation switches 150 switch data between an associated EOR switch and an appropriate router. For example, the TOR switch 110-1-1 switches data from the resources in the rack 105 to the network 100B via an appropriate EOR switch (e.g., EOR switch 140-1) and an appropriate aggregation switch (e.g., aggregation switch 150-1 or 150-2).

The routers 160 switch data between the network 100B and the data center 100A via an appropriate aggregation switch. For example, the router 160-1 may switch data from the network 100B to the data center 100A via the aggregation switch 150-1.

The network 100B includes any number of access and edge nodes and network devices and any number and configuration of links (not shown for purposes of clarity). Moreover, it should be appreciated that network 100B may include any combination and any number of wireless, or wire line networks including: LTE, GSM, CDMA, Local Area Network(s) (LAN), Wireless Local Area Network(s) (WLAN), Wide Area Network (WAN), Metropolitan Area Network (MAN), or the like.

In some embodiments, the TOR switches 120 or the EOR switches 140 are Ethernet switches. In some embodiments, the TOR switches 120 or the EOR switches 140 may be arranged to be redundant. For example, the rack 105 may be serviced by two or more TOR switches 110. In some embodiments, the aggregation switches 150 are layer 2 Ethernet switches.

One way in which the manager VM 22 manages the resources of the network 20 for the user of the VM 22 is that the VM 22 creates or retires VMs within the network based on a predetermined policy for automatically initiating a change in the number of VMs running for the user. The policy may be based on criteria, such as current network load conditions or user requests for service. The work load resulting from the user's applications can fluctuate greatly. Additionally, the user needs may change at different times. At times, the VMs initially created for the user may not be sufficient to meet the demand. One way to address this is to increase the size or computing-power of the VMs so that they can handle more work load. However, this may not be possible in some instances. For example, it is possible that the physical server or processor that houses a VM is already operating at full limits and enhancing the VM is not possible. The manager VM 22 addresses such situations by automatically initiating the process of creating additional VMs for the user when needed. The manager VM also initiates the process of retiring VMs when they are not needed anymore.

The manager VM 22 automates the process of changing the number of VMs instead of requiring a user to manually request additional computing resources. Rather than requiring the user's administrative terminal to communicate a user's need for additional VM capability to the provisioning server of the Cloud Service Provider (CSP) for creating a new VM, the manager VM 22 is configured to automatically determine when a different number of VMs would be appropriate based on the predetermined policy and communicate with the provisioning server of the CSP for creating and deleting VMs, which enhances efficiencies and resource utilization within the network 20. When a designated manager VM wants to create or delete a VM on behalf of a user, it will send a request to the CSP's provisioning server (not illustrated).

While a single manager VM 22 is illustrated, it is possible for each user of the network 20 to have more than one manager VM having the ability to signal to the provisioning server to create and delete VMs. For example, each application may have an associated manager VM.

According to one embodiment, the message for initiating or creating a new VM includes an indication of the desired characteristics of the VM, such as CPU cycles, memory, OS, etc. The message also indicates the networking requirements for the VM, such as the VLAN that the VM belongs to, the IP address(es) and Ethernet address(es) of the VM if the user wants to assign them, etc. This information can be summarized by specifying the networking and/or the computing group(s) to which the VM belongs. Additional information in the message to the provisioning server includes authentication information so that the CSP's provisioning server can authenticate the request and a digital signature that can be used by the CSP to confirm such a request has been made (e.g., for billing purposes).

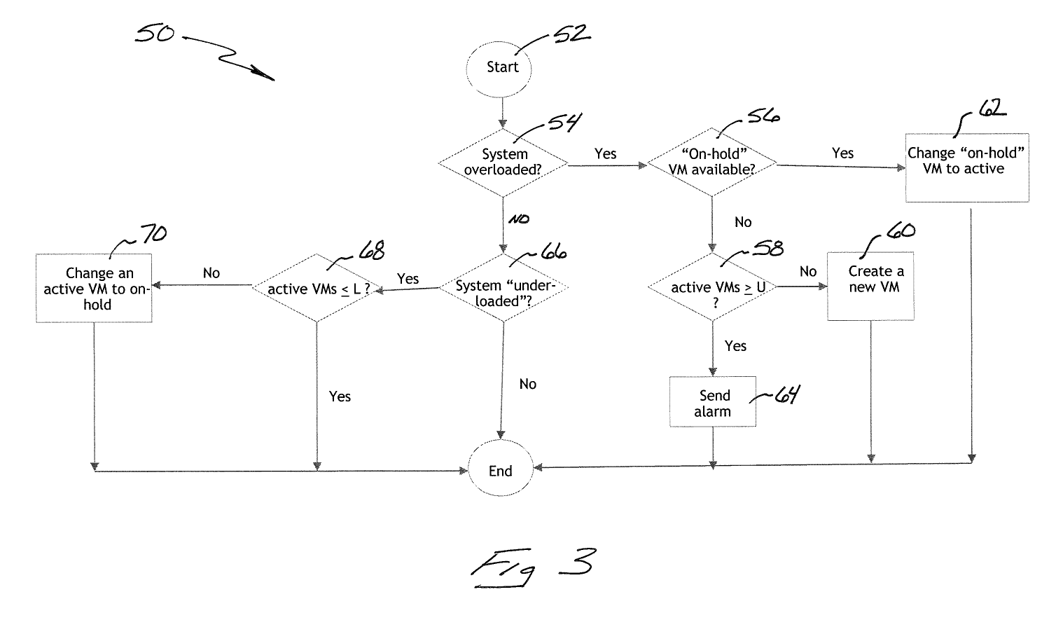

The flowchart 50 of FIG. 3 summarizes an example approach to creating or retiring VMs. The manager VM 22 monitors the aggregate work load of the processing VMs under control of the manager VM and currently running for the user. In this example, the manager VM 22 gathers (or estimates) the work load at each of the processing VMs 24-32. The manager VM 22 assigns possible states to each processing VM, such as active or on-hold. A VM in the active state is considered to be operating normally as expected. An active VM may have incoming transactions assigned to it according to applications load balancing rules used by the manager VM 22. A processing VM will start in the active mode when it is created. A VM in the on-hold state will not be assigned any newly arriving transactions from the manager VM 22. Once all the pending transactions at a processing VM are completed, the manager VM 22 may retire or delete that VM. This is the mechanism that allows the manager VM 22 to retire processing VMs from the system when the user's work load is light.

In this example two other parameters are useful. An upper limit parameter U represents the maximum number of processing VMs that is allowed (for cost control purposes). For example, it is possible to provide the privileges associated with having a manager VM to only certain users and to limit the amount of the network resources that may be occupied on behalf of that user. A lower limit parameter L represents the minimum number of processing VMs that is always active for the user. In some embodiments, L is set to 1 so that there is always at least one VM active to process new transactions for the user, without the need to create a VM at that time. Maintaining a minimum number L of VMs at all times serves to improve response time.

As shown in FIG. 3, the manager VM 22 begins the example process at 52, which may be in response to a user request or may occur on some other basis defined by the predetermined policy (e.g., periodically according to a preselected schedule). The manager VM 22 makes a determination at 54 whether the resources of the network 20 that are being used by the user (i.e., the active VMs for the user) are overloaded. In this example, only the work load of the user's active VMs is considered. The workload may be considered based on a percentage of CPU cycles at the active VMs, the number of transactions, or a combination of these among other indicators of current load.

If the current computing task load is sufficient to indicate an overload, the manager VM makes a determination at 56 whether any VMs are on-hold and available to handle a new request. Assuming that there are no such VMs, the manger VM 22 determines at 58 whether the number of currently active VMs exceeds the upper limit U. If not, the manager VM 22 automates the process of initiating a new VM at 60 by sending an appropriate request to the CSP provisioning server to create the new VM. The CSP provisioning server initiates the new VM in a known manner according to information provided by the manager VM 22.

Assuming that there was at least one on-hold VM that was available to handle a new request for service, the manager VM 22 changes such an on-hold VM to active and assigns the corresponding computing task to that VM at 62. In one example, the VM changed from on-hold to active receives any incoming transactions until that VM appears to be sufficiently loaded that new transactions would be too much for that VM.

Assuming that the maximum number U of VMs are already active when the determination at 58 is made, the manager VM 22 provides an indication at 64 to notify the CSP, the requesting user, or both that the network 20 is not capable of handling the current load requirements because a maximum number of VMs are already running for that user (or application).

Consider a situation in which the determination at 54 yields a negative result. The manager VM 22 in this situation determines at 66 whether there may be excess capacity given the current number of VMs active for the user. At 68 the manager VM determines whether the number of active VMs exceeds the minimum number L. If not, the manager VM 22 does not change the number of VMs active in the network 20. If, however, the number of VMs is greater than the minimum L, then the manager VM 22 changes the status of at least one of the currently active VMs to on-hold.

In one example, the manager VM 22 will retire one or more on-hold VMs to avoid keeping VMs that are not needed during times of low load. If there is excess capacity, the manager VM identifies at least one of the VMs under its control to retire. That VM may already be on-hold or be placed on-hold. The identified VM will not be assigned any new computing tasks and will be allowed to complete any computing tasks currently assigned to it. Once those are complete, the VM may be retired.

For some applications, it is possible to migrate some transactions in progress from one VM to another VM in a graceful manner, without errors and interruptions. For these applications, the manager VM 22 could instruct a VM which is in the on-hold state to migrate transactions in progress to one or more active VMs, specified by the manager VM 22. With this migration, an on-hold VM could be retired earlier.

Another way in which the manager VM 22 manages the network resources is by controlling the flow of communications among the resources in the event that a VM retires or mirrored VMs are used.

Most hypervisors support the capability to move an operating VM from one server to another. This capability is commonly referred to as VM migration. The newly created VM will take on all the characteristics of the original VM. In most cases, this implies that the new VM will have the same IP addresses and Ethernet addresses as the original VM. Because of this, a forwarding table of the layer switches should be updated so that layer 2 packets addressed to the Ethernet address of the original VM should be forwarded to the new location instead of the original one.

During a short time period that immediately follows the switch over, the forwarding tables at the layer 2 switches may not be updated quick enough to reflect the change of location of this Ethernet address. Some packets may also already be in transit in the network. Therefore, some packets may be delivered to the old location instead of the new one. This example includes a technique that will allow the TOR switch of the original VM to redirect packets for the VM to the new location.

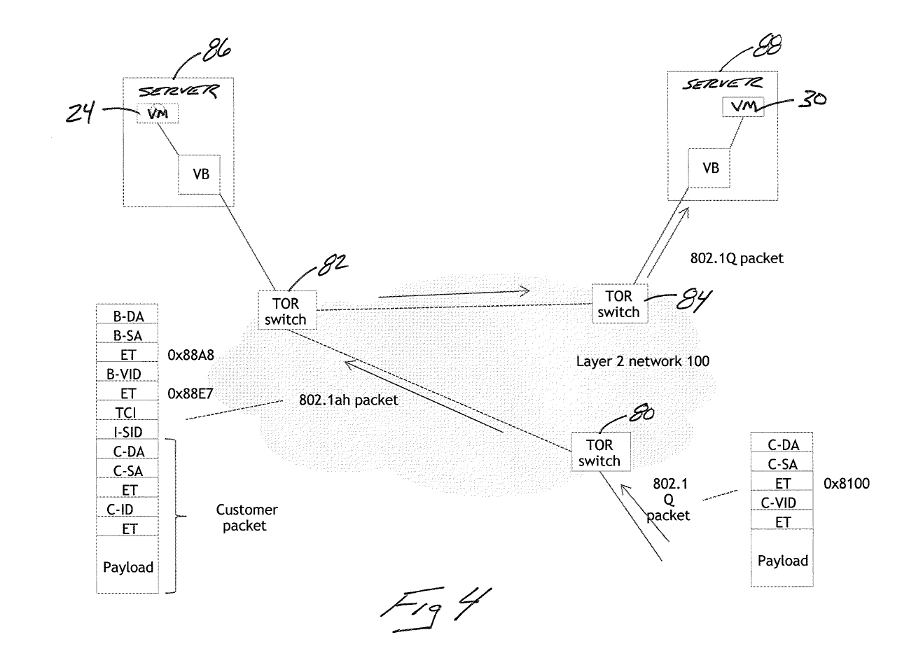

FIG. 4 schematically shows how communications, such as user packets, can be directed among the TOR switches shown at 80, 82 and 84, which are layer 2 resources of the network 20. For discussion purposes, the network may be considered an 801.ah (M-in-M provider backbone bridging network). TOR switches 80-84 are backbone edge bridges (BEB). The example VM 24 was running on a processor or server 86 and is the “original VM” which has just been retired. The “new VM” in this example is the VM 30 which is hosted in another server 88. The server 86 is connected to the TOR switch 82 and the server 88 is connected with the TOR switch 84.

VM 24 has an Ethernet address A before its retirement. Through a known learning process or commands from the network OpenFlow controller the BEBs in the network 20 would know that the module with Ethernet address A is attached to the TOR switch 82. When the TOR switch 80 receives an 802.1q packet, with destination address A and source address B, from an attached device, it will first consult its forwarding table. The forwarding table indicates that address A is attached to TOR switch 82. It will attach an outer header to the incoming 802.1 packet as specified in the 802.1ah standard.

According to the illustrated example, the outer header includes the following elements: a backbone destination address B-DA, which is the Ethernet address of the egress BEB (i.e., the TOR switch 82); a backbone source address B-SA, which is the Ethernet address of the ingress BEB (i.e., the TOR switch 80); a B-Tag which consists of an Ethertype field ET encoded as 0x88A8 (0x indicates hex values) and the ID of the backbone VLAN B-VID. The outer header also includes the following service related elements: ET, which is an Ether type encoded as 0x88E8; TCI, which is a tag control information field that is 8 bits long and contains the several control parameters, such as a 3 bit priority code point I-PCP, a 1 bit drop eligibility indication I-DEI and a service identifier I-SID.

The incoming packet in this example will be attached following the above information without modification. Layer 2 of the network will forward this packet to the TOR switch 82 as the outer destination packet is encoded with its address. Upon receipt of this packet, the TOR switch 82 will remove the outer header and examine the destination of the inner destination address, which would be address A in this example. Before VM 24 migrates, the TOR switch 82 would know that this address is located at server 86 and would forward the packet to server 86. When the VM manager migrates the VM 24 at server 86 to VM 30 at server 88, one would like to re-direct this packet to server 88.

When the manager VM 22 retires VM 24 and activates VM 30, the VM 22 will send a command, through the OpenFlow controller or the EMS of the layer 2 network, to the TOR switch 82 instructing the TOR switch 82 to redirect packets destined for address A to the TOR switch 84. With its forwarding table updated accordingly, when the TOR switch 82 receives a packet destined to address A, it will encapsulate the packet with an outer header (as described above). The backbone-destination-address will be encoded with the Ethernet address of the TOR switch 84, while the backbone-source-address will be encoded with the Ethernet address of the TOR switch 82.

In addition, the packet would also be encoded with an indication that this is a re-directed packet. There are many ways to do this. In one embodiment of the invention, one of the reserved bits in the TCI field can be used to indicate that this is a re-directed packet. When this bit is set to indicate a redirected packet, the customer address learning at the egress BEB (TOR switch 84 in this example) would be disabled for this packet. Under normal circumstances, when a TOR switch receives a packet from another switch in the backbone layer 2 network, the learning process will associate the customer source-address from the inner header (address B in this example) with the backbone source address from the outer header (address of TOR switch 80 for the original packet and address of TOR switch 82 for the re-directed packet). The association for the re-directed packet is incorrect and so the learning process should be disabled for this packet.

In another embodiment of the invention, for the redirected packet, the address of the original ingress BEN (TOR switch 80 in this example) will be appended to the end of the outer header. The egress BEB can use this information to update the forwarding table in the learning process instead of the backbone-source-address.

Once activated the VM 30 transmits packets in the normal course of operation. These packets will update the forwarding tables of the edge TOR switches in the network. Thus, after some time all the forwarding tables would be updated (either by the learning process or commands from the OpenFlow controller or EMS), and the re-direct functions would not be needed at the TOR switch 82. Therefore, a timer value may be included in the re-direction command. A timer with the indication value will start at the TOR switch 82 when it receives the re-direct command. At the expiration of the timer, the re-direct function for address A will then be removed from the forwarding table.

The use of one of the reserved bits in the TCI to indicate re-directed packets may be the subject of future standardization in 802.1. Another way to encode indication this without the need of standardization is use one of the bits in the service identifier field I-SID, which is a 24 bit field that can be used by the network operator to indicate the service associated with the packet. One of those bits can be used to indicate a redirected packet. Of course, the number of service instances would be reduced to 2²³ (instead of 2²⁴), but it is still a very large number. FIG. 4 schematically illustrates the TCI and I-SID fields of the 802.1ah outer header and how they can be used to indicate redirected packets. Other similar methods are also possible.

In the above description, the layer 2 network is assumed to be a PBB (802.1ah) network. The same process applies if the layer 2 network is a PB (802.1ad) network or an OpenFlow network. The example packet used for discussion purposes is a 802.1 q packet but it could also be an untagged 802.1 basic packet or a 802.1ad (Q-in-Q) packet.

Another feature of the example cloud computing network 20 is that it includes an addressing strategy that takes advantage of the hierarchical arrangement of the resources of the data center architecture shown in FIG. 2. A hierarchical addressing strategy provides a default table for communicating packets that works well under most circumstances within such a data center architecture. The layer 2 network exhibits a hierarchical structure from the aggregation switch to the EOR switch to the TOR switches to the servers to the VMs. By appropriately addressing packets, a reduced size, compact default forwarding table can be realized that renders the network 20 faster and the switches can be realized less expensively.

In some embodiments the Ethernet addresses of the VMs are assigned by the cloud service provider (CSP) when the VMs are created. The access portion of the layer 2 network in a data center architecture, such as that shown in FIG. 2, has a high degree of hierarchy: VM to VB to TOR switch. Therefore, by structuring the address format that tracks the hierarchy, the size of the forwarding table can be greatly reduced.

An Ethernet address, which may be octets long, typically comprises two control bits; a first control bit that is the U/M bit which is used to indicate whether the Ethernet packet is an uni-cast packet or a multicast packet, and a second control bit that is the G/L bit which is to indicate whether the address is globally unique address or a locally administered address. If the address is a globally unique address, the address is administered by IEEE. In this case, the next 22 bits are used to indicate the organization that administers the sequent address block. This field is commonly referred as the OUI (Organization Unique Identifier). Note that an organization can own multiple OUI blocks. For globally unique addresses, the rest of the 24 bits can be assigned to the designated organization for their use. If the G/L bit is set to be locally administered, then the rest of the 46 bits can be used by the user locally (within the organization).

Consider the case that the cloud service provider (CSP) would assign locally administered addresses to VMs. The following address scheme can be used to simplify the forwarding tables at a layer 2 switch. The basic concept is that every VM is associated with a preferred server. The preferred mode of operation is to have the VM to be housed at that server. However, the above condition is not a necessary condition and a VM with any Ethernet address can be placed at any server. This way VM migration and other services can be supported.

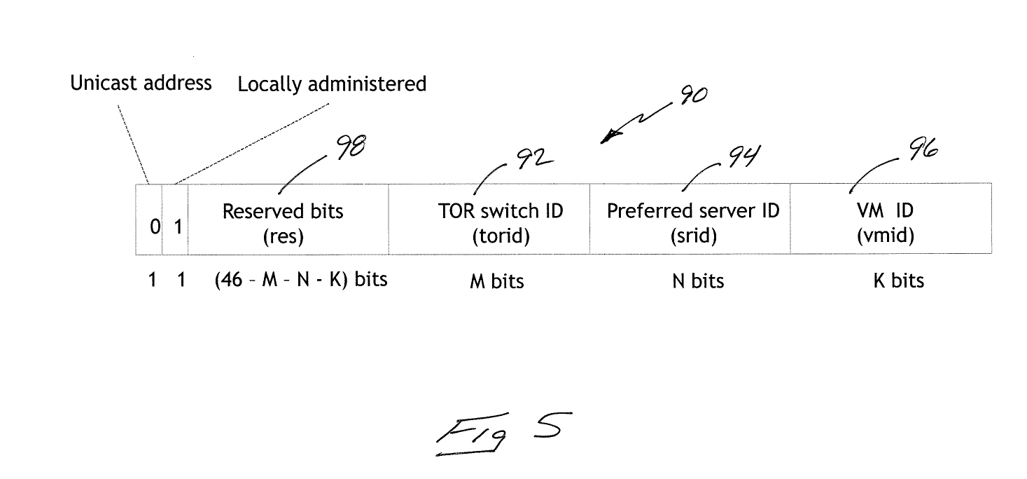

An example address format 90 of a VM using hierarchical addressing for locally administered addresses is illustrated in FIG. 5. In this example the address includes a field 92 that identifies a TOR switch (torid), a field 94 that identifies a server (srid) that is attached to the TOR switch indicated at 92, and a field 96 that uniquely identifies a logical network interface of a VM (vmid) that has the server identified at 94 as its preferred server.

The size of the fields 92-96 may be based on the layer 2 network design of the data center. A reasonable estimate would be 6-10 bits for the vmid and srid, and 8-12 bits for the torid. Since there are a total of 46 bits there are still 12-22 bits left which can be used for other purpose, such as to give more information on the location of the TOR switch (ID of the layer 2 network, data center, etc.). These bits are reserved in this example and shown at 98 in FIG. 5. For discussion purposes all the reserved bits are set to 0.

The layer 2 address of a VM can be represented as (res=0, torid, srid, vmid) where vmid uniquely identifies the network connector with the corresponding server as the preferred server. Once assigned, the VM will maintain the assigned layer 2 address for all its connectors even if the VM is migrated to another server.

In many cases, the VM will reside at its preferred server so that a simple default forward table may be set up at all the switches. The default forwarding action is to forward a packet to the TOR switch as indicated by the “torid” field of the destination address of the packet. When a VM is moved from its preferred server, through the learning process or commands from the controller, an entry will be created eventually at a forwarding table, with higher precedence to the default forwarding table at all the switches. Packets for the VM will be forwarded to the new location based on this higher precedence table. Thus, forwarding entries are only created when a VM is not at its preferred server. This will greatly reduce the size of the forwarding table at the switches.

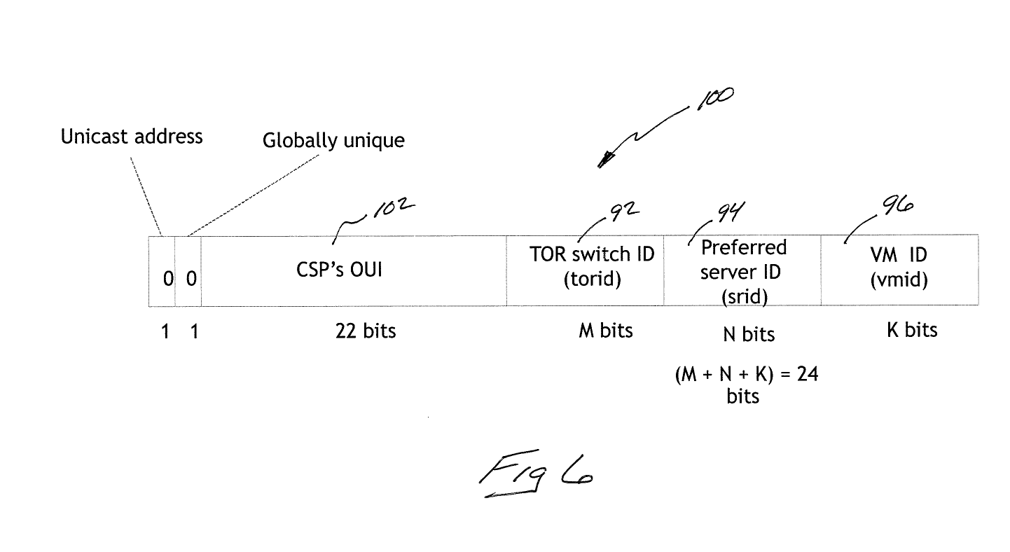

The CSP can also acquire global addresses from the IEEE and use them for assignment to VMs. The size of the address field that is administered by the CSP is 24 bits which is less than using locally administered address. However, it may still be sufficient for many networks (e.g., 7, 7 and 10 bits for torid, srid, and vmid, respectively). The address format 100 of a VM using hierarchical addressing for globally unique addresses is illustrated in FIG. 6. In this example, the Organization Unique Identifier (OUI) is represented in the 22 bit field 102. The other fields that have the same reference numbers as shown in FIG. 5 include the same information described above.

In some instances, the user may want to assign Ethernet address to the logical interface of the VMs themselves rather than letting the CSP assign them. If the layer 2 addresses are globally unique, the assignment does not need to adhere to the hierarchical scheme. In other words, the value in OUI field would be different from the OUI of the CSP. Entries may be created in the forwarding table for these addresses in a known manner (e.g., through the learning process or via commands from the controller). If the addresses are locally administered (i.e., “local” applies to the customer), address translation may be needed to avoid conflict (between the user and CSP as well as between users). The address translation function can be carried out at either the VB or the TOR switches. The TOR switches usually have optimized hardware or firmware to carry out such an address translation function

The preceding description is illustrative rather than limiting in nature. Variations and modifications to the disclosed examples may become apparent to those skilled in the art that do not necessarily depart from the essence of the contribution to the art provided by the disclosed embodiments. The scope of legal protection can only be determined by studying the following claims.

We claim:

1. A cloud computing network, comprising:
a plurality of resources configured to run at least one virtual machine; and
at least one resource configured to run a manager virtual machine for a user to automatically initiate a change in a number of virtual machines running for the user on at least one of the plurality of resources.

2. The cloud computing network of claim 1, wherein the manager virtual machine
determines at least one characteristic of a created virtual machine;
determines a location of the created virtual machine in the network by selecting one of the plurality of resources for running the created virtual machine; and
determines routing information for directing communications between the created virtual machine and another device.

3. The cloud computing network of claim 1, wherein the manager virtual machine
determines a load condition of virtual machines running for the user;
determines whether a new virtual machine is desired based on the determined load condition.

4. The cloud computing network of claim 1, wherein the manager virtual machine
determines a load condition of virtual machines running for the user;
determines whether retiring a running virtual machine is desired based on the determined load condition;
identifies a running virtual machine as one that will be retired if retiring a running virtual machine is desired;
places the identified virtual machine into an on-hold status; and
initiates transaction migration from the identified on-hold virtual machine to another virtual machine that has an active status.

5. The cloud computing network of claim 1, wherein
the network includes
a first switch, and
a plurality of second switches between the first switch and the plurality of resources, the plurality of second switches interface with the first switch,
the plurality of resources and others of the second switches;
the manager virtual machine determines when a virtual machine at a first one of the resources retires;
the manager virtual machine provides an indication to the second switch that interfaces with the first one of the resources to route communications intended for the retired virtual machine to another one of the second switches that interfaces with a second one of the resources running a virtual machine that replaces the retired virtual machine.

6. The cloud computing network of claim 5, wherein the indication provided by the manager virtual machine has a time limit after which the indication expires.

7. The cloud computing network of claim 1, wherein the manager virtual machine
determines a load condition of virtual machines running for the user;
determines if at least one virtual machine running for the user has an on-hold status; and
changes the at least one virtual machine to an active status based on an increase in the determined load condition.

8. The cloud computing network of claim 1, comprising:
a plurality of top-of-rack (TOR) switches configured to interface with the plurality of resources;
at least one end-of-row (EOR) switch configured to interface with the plurality of TOR switches; and
an aggregation switch configured to communicate with the at least one EOR switch, the aggregation switch being configured to interface with a device external to the network;
and wherein
a packet addressed to one of the virtual machines includes:
an identifier of the TOR switch associated with the resource running the one of the virtual machines,
an identifier of the resource running the one of the virtual machines, and
an identifier of the one of the virtual machines.

9. The cloud computing network of claim 8, wherein
the aggregation switch, the at least one EOR switch and the TOR switches are arranged in a hierarchical order; and
the identifier of the TOR switch, the identifier of the resource and the identifier of the virtual machine are arranged in the packet in an order corresponding to the hierarchical order.

10. The cloud computing network of claim 1, wherein the manager virtual machine maintains a number of running virtual machines for the user between a preselected minimum and a preselected maximum.

11. A method of managing cloud computing resources, comprising:
using a manager virtual machine running on at least one resource for a user to automatically initiate a change in a number of virtual machines running for the user on at least one of a plurality of resources.

12. The method of claim 11, comprising
determining at least one characteristic of a created virtual machine;
determining a location of the created virtual machine by selecting one of the plurality of resources for running the created virtual machine; and
determining routing information for directing communications between the created virtual machine and another device.

13. The method of claim 11, comprising
determining a load condition in the network;
determining whether a new virtual machine is desired based on the determined load condition.

14. The method of claim 11, comprising
determining a load condition in the network;
determining whether retiring a running virtual machine is desired based on the determined load condition;
identifying a running virtual machine as one that will be retired if retiring a running virtual machine is desired;
placing the identified virtual machine into an on-hold status; and
initiating transaction migration from the identified on-hold virtual machine to another virtual machine that has an active status.

15. The method of claim 11, wherein
the resources comprise
a first switch, and
a plurality of second switches between the first switch and the plurality of resources, the plurality of second switches interface with the first switch, the plurality of resources and others of the second switches;
and the method comprises
determining when a virtual machine at a first one of the resources retires;
providing an indication from the manager virtual machine to the second switch that interfaces with the first one of the resources to route communications intended for the retired virtual machine to another one of the second switches that interfaces with a second one of the resources running a virtual machine that replaces the retired virtual machine.

16. The method of claim 15, wherein the indication provided by the manager virtual machine has a time limit after which the indication expires.

17. The method of claim 15, comprising:
determining a load condition of the network;
determining if at least one virtual machine has an on-hold status; and
changing the at least one virtual machine to an active status based on an increase in the determined load condition.

18. The method of claim 1, wherein
the resources comprise:
a plurality of top-of-rack (TOR) switches configured to interface with the plurality of resources;
at least one end-of-row (EOR) switch configured to interface with the plurality of TOR switches; and
an aggregation switch configured to communicate with the at least one EOR switch, the aggregation switch being configured to interface with a device external to the network;
and the method includes
addressing a packet intended for one of the virtual machines with:
an identifier of the TOR switch associated with the resource running the one of the virtual machines,
an identifier of the resource running the one of the virtual machines, and
an identifier of the one of the virtual machines.

19. The method of claim 18, wherein
the aggregation switch, the at least one EOR switch and the TOR switch are arranged in a hierarchical order; and
the identifier of the TOR switch, the identifier of the resource and the identifier of the virtual machine are arranged in the packet in an order corresponding to the hierarchical order.

20. The method of claim 1, comprising maintaining a number of running virtual machines between a preselected minimum and a preselected maximum.
